(19) United States
(12) Patent Application Publication
(10) Pub. No.: US 2015/0015832 A1
(43) Pub. Date: Jan. 15, 2015

(54) OPTICAL FILM, POLARIZING PLATE, AND LIQUID CRYSTAL DISPLAY DEVICE

(71) Applicant: FUJIFILM Corporation, Tokyo (JP)

(72) Inventors: Masato NAGURA, Kanagawa (JP); Yoshiaki HISAKADO, Kanagawa (JP)

(73) Assignee: FUJIFILM Corporation, Tokyo (JP)

(21) Appl. No.: 14/329,044

(22) Filed: Jul. 11, 2014

(30) Foreign Application Priority Data
Jul. 12, 2013 (JP) 2013-146337

(51) Int. Cl. G02F 1/1335; C08L 67/00; C08L 1/08; G02B 5/30

(52) U.S. Cl. CPC G02F 1/133528; G02B 5/3083; C08L 67/00; C08L 1/08
USPC 349/96; 359/489.07; 428/220

(57) ABSTRACT

Disclosed is an optical film having a cellulose ester and a polyester containing an alicyclic structure and having a hydroxyl terminal group, a hydrogen atom of which is substituted by an acyl group derived from a monocarboxylic acid, and having a thickness of from 10 to 45 μm, an in-plane retardation of from −5 to 5 nm, a retardation in thickness direction of from −5 to 5 nm, and an elastic modulus of 4.2 GPa or more. The optical film has a reduced thickness, achieves both a high rigidity and optical characteristics including a low retardation, and enhances the polarizer durability used in a polarizing plate.

### CROSS-REFERENCE TO RELATED APPLICATIONS

The present application claims the benefit of priority from Japanese Patent Application No. 2013-146337, filed on Jul. 12, 2013, the contents of which are herein incorporated by reference in their entirety.

### BACKGROUND OF THE INVENTION

1. Field of the Invention

The present invention relates to an optical film useful for a liquid crystal display device, and a polarizing plate and a liquid crystal display device having the optical film.

2. Description of the Related Art

A cellulose ester film, which is represented by a cellulose acetate film, has high transparency and thus has been used as an optical film for various purposes in a liquid crystal display device. For example, a cellulose ester film is used as a polarizing plate protective film in a liquid crystal display device since adhesiveness to polyvinyl alcohol used in a polarizer may be easily secured.

In recent years, a liquid crystal display device, particularly a liquid crystal display device for a middle sized or small sized equipment, undergoes drastic reduction in thickness, and thus reduction in thickness of members used therein, particularly reduction in thickness of a polarizing plate protective film (such as a protective film having a hardcoat layer provided on a surface of a liquid crystal device, a protective film functioning as a retardation film, and an ordinary protective film having a small phase difference), is being demanded.

As a film used in a liquid crystal display device, for example, JP-A-2004-292696 describes that a cellulose acylate film containing a polyester polymer containing a polyester component, which is derived from a diol containing an alicyclic structure and a dicarboxylic acid derivative having an alicyclic structure, and cellulose acylate has an increased tear strength.

JP-A-2007-84692 describes that a cellulose ester film containing an ester plasticizer having benzene carboxylic acid or phenol residual groups at both terminals thereof and having an alicyclic glycol and an alicyclic dibasic acid has an increased durability of the optical capability against humidity change.

The present inventors produce films, which are formed of a cellulose ester containing some of the aliphatic ester oligomers described in JP-A-2004-292696 and JP-A-2007-84692, for achieving reduction in thickness of an optical film used in an IPS liquid crystal display device, and it has been thus found that problems in production and handling properties occur in the film due to the decreased rigidity thereof, and the rolled film suffers concavoconvex deformation (which may be hereinafter referred to as a dent bump) on the surface of the roll on storing.

It has also been found that the films, which are formed of a cellulose ester containing some of the aliphatic ester oligomers described in JP-A-2004-292696 and JP-A-2007-84692, has deteriorated polarizer durability used in a polarizing plate or has a high retardation with a small amount of the aliphatic oligomer added, even if the dent bump does not occur depending on the species of the aliphatic ester oligomer used.

JP-A-2004-292696 and JP-A-2007-84692 do not describe the rigidity of the films, and the films described in the examples exhibit a high retardation, from which it has been found that the use of the films in an IPS liquid crystal display device considerably deteriorates the display performance.

### SUMMARY OF THE INVENTION

An object of the invention is to provide an optical film that has a reduced thickness, achieves both a high rigidity and optical characteristics including a low retardation, and enhances the polarizer durability used in a polarizing plate, and a polarizing plate and a liquid crystal device using the optical film.

As a result of earnest investigations made by the inventors for solving the aforementioned problems, it has been found that the problems are solved by adding a polyester having a hydroxyl terminal group, a hydrogen atom of which is substituted by an acyl group derived from a monocarboxylic acid.

The invention relates to the following embodiments.

1. An optical film containing

a cellulose ester and

at least one kind of a polyester containing an alicyclic structure and having a hydroxyl terminal group, a hydrogen atom of which is substituted by an acyl group derived from a monocarboxylic acid, and

having a thickness of from 10 to 45 μm, an in-plane retardation (Re) at a wavelength of 590 nm under an environment of 25° C. and 60% RH of from −5 to 5 nm, a retardation in thickness direction (Rth) at a wavelength of 590 nm under an environment of 25° C. and 60% RH of from −5 to 5 nm, and an elastic modulus of 4.2 GPa or more.

2. The optical film according to the item 1, wherein the polyester preferably has a number average molecular weight Mn of from 500 to 3,000.

3. The optical film according to the item 1 or 2, wherein the polyester is preferably derived from a polymer of an acyclic aliphatic diol and a dicarboxylic acid having an alicyclic structure, or a polymer of an aliphatic diol having an alicyclic structure and an acyclic aliphatic dicarboxylic acid.

4. The optical film according to any one of the items 1 to 3, wherein the polyester preferably contains a repeating unit represented by the following formula (1):

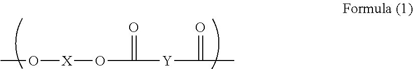

wherein X represents an acyclic divalent linking group having from 2 to 10 carbon atoms, and Y represents a linking group having from 3 to 12 carbon atoms containing a 3- to 6-membered alicyclic structure.

5. The optical film according to any one of the items 1 to 4, wherein the monocarboxylic acid is preferably an aliphatic monocarboxylic acid having from 2 to 10 carbon atoms.

6. The optical film according to any one of the items 1 to 5, wherein the polyester preferably has a hydroxyl group value of 10 mgKOH/g or less.

7. The optical film according to any one of the items 1 to 6, wherein a content of the polyester is preferably from 5 to 20% by mass based on the cellulose ester.

8. A polarizing plate containing at least one sheet of the optical film according to any one of the items 1 to 7.

9. A liquid crystal display device containing a liquid crystal cell and two sheets of polarizing plates disposed on both sides of the liquid crystal cell, at least one of the polarizing plates having the polarizing plate according to the item 8.

10. The liquid crystal display device according to the item 9, wherein the liquid crystal cell is preferably an in-plane switching mode (IPS) liquid crystal cell.

11. The liquid crystal display device according to the item 9 or 10, wherein the optical film according to any one of the items 1 to 7 is preferably disposed between a polarizer and the liquid crystal cell.

According to the invention, an optical film may be provided that has a reduced thickness, achieves both a high rigidity and optical characteristics including a low retardation, and enhances the polarizer durability used in a polarizing plate.

### DETAILED DESCRIPTION OF THE INVENTION

The invention will be described in detail with reference to embodiments below. While the constitutional elements of the invention may be described with reference to the embodiments, the invention is not limited to the embodiments. In the description, the expression for numeral ranges “from A to B” means that the values A and B are included in the range as the lower and upper limits respectively, and the expression for numeral ranges “A or more” or “A or less” means that the value A is included in the range as the lower or upper limit respectively.

### Optical Film

According to one embodiment of the invention, the optical film contains a cellulose ester and at least one kind of a polyester containing an alicyclic structure and having a hydroxyl terminal group, a hydrogen atom of which is substituted by an acyl group derived from a monocarboxylic acid, and the optical film has a thickness of from 10 to 45 μm, an in-plane retardation (Re) at a wavelength of 590 nm under an environment of 25° C. and 60% RH of from −5 to 5 nm, a retardation in thickness direction (Rth) at a wavelength of 590 nm under an environment of 25° C. and 60% RH of from −5 to 5 nm, and an elastic modulus of 4.2 GPa or more.

In the optical film of the embodiment using the polyester containing an alicyclic structure and having a hydroxyl terminal group, a hydrogen atom of which is substituted by an acyl group derived from a monocarboxylic acid, the ester oligomer may exist to fill the free volume of the cellulose ester, and thereby such an optical film may be provided that has a high rigidity and a low retardation and exhibits a high polarizer durability used in a polarizing plate, irrespective of the small thickness thereof.

Preferred embodiments of the optical film of the invention will be described below.

### Cellulose Ester

The optical film according to an embodiment of the invention contains one or more kinds of a cellulose ester as a major component. Examples of the cellulose ester include a cellulose ester compound and a compound having an ester-substituted cellulose structure obtained by introducing biologically or chemically a functional group to cellulose as a raw material. The term “major component” herein means, in the case where only one kind of a polymer is contained, the polymer, and in the case where two or more kinds of polymers are contained, the polymer that has the largest mass fraction.

The cellulose ester is an ester of cellulose and an acid. The acid constituting the ester is preferably an organic acid, more preferably a carboxylic acid, further preferably a fatty acid having from 2 to 22 carbon atoms, and most preferably a lower fatty acid having from 2 to 4 carbon atoms, forming cellulose acylate.

Examples of cellulose as a raw material of the cellulose acylate include cotton linter and wood pulp (such as hardwood pulp and softwood pulp), and all kinds of cellulose obtained therefrom may be used and may be used after mixing plural kinds thereof depending on necessity. For the cellulose as a raw material, reference may be made, for example, to “Plastic Zairyo Koza (17) Senisokei Jushi” (Lectures on Plastic Materials (17) Cellulose Resins), by Marusawa and Uda, published by Nikkan Kogyo Shimbun, Ltd., 1970, and JIII Journal of Technical Disclosure Monthly, 2001-1745 (pp. 7-8), and all kinds of cellulose described therein may be used.

The cellulose acylate used in the embodiment is obtained by substituting a hydrogen atom of a hydroxyl group of cellulose by an acyl group. The acyl group preferably has from 2 to 22 carbon atoms. The acyl group may be an aliphatic acyl group or an aromatic acyl group, and the cellulose may be substituted by one kind of an acyl group or by plural kinds of acyl groups. Specific examples of the cellulose acylate include an alkylcarbonyl ester, an alkenylcarbonyl ester, an aromatic carbonyl ester and an aromatic alkylcarbonyl ester of cellulose. The alkyl moiety, the alkenyl moiety, the aromatic moiety and the aromatic alkyl moiety may further have a substituent. Preferred examples of the acyl group include acetyl, propionyl, butanoyl, heptanoyl, hexanoyl, octanoyl, decanoyl, dodecanoyl, tridecanoyl, tetradecanoyl, hexadecanoyl, octadecanoyl, i-butanoyl, t-butanoyl, cyclohexanecarbonyl, oleoyl, benzoyl, naphthylcarbonyl and cinnamoyl groups. Among these, acetyl, propionyl, butanoyl, dodecanoyl, octadecanoyl, t-butanoyl, oleoyl, benzoyl, naphthylcarbonyl, cinnamoyl and the like are preferred, acetyl, propionyl and butanoyl are more preferred, and acetyl is most preferred.

The acylation degree of the cellulose acylate used is not particularly limited, and the cellulose acylate that has an acylation degree of from 2.00 to 2.95 is preferably used from the standpoint of the film forming property and the various characteristics of the film thus produced. The acylation degree may be obtained by measuring the ratio of a fatty acid, such as acetic acid, bonded to the cellulose, from which the acylation degree may be calculated. The acylation degree may be measured according to ASTM D-817-91.

In an example of the cellulose acylate having two or more kinds of an acyl groups selected from an acetyl group, a propionyl group and a butanoyl group, the total acylation degree is preferably from 2.50 to 2.95, more preferably from 2.60 to 2.95, and further preferably from 2.65 to 2.95.

In an example of the cellulose acylate having only an acetyl group, i.e., cellulose acetate, the total acetylation degree is preferably from 2.00 to 2.95, more preferably from 2.40 to 2.95, and further preferably from 2.85 to 2.95.

The polymerization degree of the cellulose acylate that is preferably used in the embodiment is preferably from 180 to 700 in terms of viscosity average polymerization degree, and for cellulose acetate, the polymerization degree thereof is more preferably from 180 to 550, further preferably from 180 to 400, and particularly preferably from 180 to 350, in terms of viscosity average polymerization degree. When the polymerization degree is not more than the upper limit, the dope solution of the cellulose acylate may not have a too high viscosity, and a film may be readily produced by casting. When the polymerization degree is not less than the lower limit, problems including a too low strength of the film may be avoided. The viscosity average polymerization degree may be measured by the limiting viscosity method by Uda, et al. (see K. Uda and H. Saito, Journal of the Society of Fiber Science and Technology, Japan, vol. 18, No. 1, pp. 105-120 (1962)). The measurement method is also described in detail in JP-A-9-95538.

The molecular weight distribution of the cellulose acylate that is preferably used in the embodiment may be evaluated by gel permeation chromatography, and the polydispersion index Mw/Mn (wherein Mw represents the mass average molecular weight, and Mn represents the number average molecular weight) thereof is preferably small, i.e., the molecular weight distribution is preferably narrow. Specifically, the value of Mw/Mn is preferably from 1.0 to 4.0, more preferably from 2.0 to 4.0, and further preferably from 2.3 to 3.4.

### Polyester

The polyester used in the embodiment will be described.

The polyester contains an alicyclic structure and has a hydroxyl terminal group, a hydrogen atom of which is substituted by an acyl group derived from a monocarboxylic acid. It is expected that the ester oligomer may exist to fill the free volume of the cellulose ester to increase the proportion of the rigid alicyclic structure, and thereby such an optical film may be provided that has a high rigidity and a low retardation.

The polyester is not particularly limited, as far as the polyester contains an alicyclic structure and has a hydroxyl terminal group, a hydrogen atom of which is substituted by an acyl group derived from a monocarboxylic acid, and is preferably a derivative derived from a polymer of an acyclic aliphatic diol and a dicarboxylic acid having an alicyclic structure, or a derivative derived from a polymer of an aliphatic diol having an alicyclic structure and an acyclic aliphatic dicarboxylic acid, and more preferably a derivative derived from a polymer of an acyclic aliphatic diol and a dicarboxylic acid having an alicyclic structure among these.

The polyester particularly preferably contains an alicyclic structure in the main chain thereof and has a hydroxyl terminal group, a hydrogen atom of which is substituted by an acyl group derived from a monocarboxylic acid, from the standpoint that the hardness of the resulting film may be enhanced only by substituting the constitutional units of the linear aliphatic moiety by a cyclic structure, and the polyester further preferably has a main chain that is a derivative derived from a polymer of an acyclic aliphatic diol and a dicarboxylic acid having an alicyclic structure, or a derivative derived from a polymer of an aliphatic diol having an alicyclic structure and an acyclic aliphatic dicarboxylic acid, and still further preferably a derivative derived from a polymer of an acyclic aliphatic diol and a dicarboxylic acid having an alicyclic structure among these, and yet further preferably contains specifically a repeating unit represented by the following formula (1):

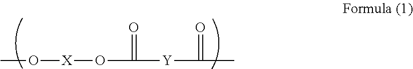

wherein X represents an acyclic divalent linking group having from 2 to 10 carbon atoms, and Y represents a linking group having from 3 to 12 carbon atoms containing a 3- to 6-membered alicyclic structure.

In the formula (1), X represents an acyclic divalent linking group having from 2 to 10 carbon atoms, preferably an acyclic divalent linking group having from 2 to 8 carbon atoms, and more preferably an acyclic divalent linking group having from 2 to 6. Examples of the linking group represented by X include an alkylene group (preferably having from 2 to 10 carbon atoms, more preferably from 2 to 8 carbon atoms, and particularly preferably from 2 to 6 carbon atoms) and alkynylene group (preferably having from 3 to 12 carbon atoms, more preferably from 3 to 10 carbon atoms, and particularly preferably from 3 to 6 carbon atoms), and the linking group may contain an atom other than carbon, such as an oxygen atom and a nitrogen atom. The divalent linking group may have a substituent, and examples of the substituent include an alkyl group, an alkoxy group, a hydroxyl group, an alkoxy-substituted alkyl group and a carboxyl group.

The term “acyclic” herein means one that does not contain a cyclic structure, examples of a group that does not contain a cyclic structure include a linear group and a branched group.

In the formula (1), Y represents a linking group having from 3 to 12 carbon atoms containing a 3- to 6-membered alicyclic structure, and the linking group represented by Y preferably has from 3 to 10 carbon atoms, more preferably from 3 to 8 carbon atoms, and further preferably from 3 to 6 carbon atoms. Examples of the linking group represented by Y include an alkylene group having an alicyclic structure (preferably having from 3 to 12 carbon atoms, more preferably from 3 to 10 carbon atoms, and particularly preferably from 3 to 6 carbon atoms) and alkynylene group having an alicyclic structure (preferably having from 3 to 12 carbon atoms, more preferably from 3 to 10 carbon atoms, and particularly preferably from 3 to 6 carbon atoms). The alicyclic structure contained in Y may be a monocyclic structure or a polycyclic structure as far as the alicyclic structure is a 3- to 6-membered alicyclic structure, and is preferably a monocyclic structure. The alicyclic structure is a 3- to 6-membered alicyclic structure, and preferably a 5- or 6-membered alicyclic structure. Specific examples thereof include a cyclopropylene group, a 1,2-cyclobutylene group, a 1,3-cyclobutylene group, a 1,2-cyclopentylene group, a 1,3-cyclopentylene group, a 1,2-cyclohexylene group, a 1,3-cyclohexylene group and a 1,4-cyclohexylene group. The linking group may have a substituent, and examples of the substituent include an alkyl group, an alkoxy group, a hydroxyl group, an alkoxy-substituted alkyl group and a carboxyl group. The alicyclic structure may have a substituent, and examples of the substituent on the alicyclic structure include an alkyl group, an alkoxy group, a hydroxyl group, an alkoxy-substituted alkyl group and a carboxyl group, and preferred examples thereof include a methyl group.

The number average molecular weight (Mn) of the polyester in the embodiment is preferably from 500 to 3,000, more preferably from 600 to 1,500, and further preferably from 800 to 1,200. When the number average molecular weight of the polyester is 500 or more, the polyester may have low volatility, and the resulting optical film may be prevented from undergoing malfunction and process contamination due to volatilization thereof under a high temperature condition on stretching the optical film. When the number average molecular weight thereof is 3,000 or less, the polyester may have high compatibility with the cellulose ester, and the resulting optical film may be prevented from undergoing bleed out of the polyester in the production of the film and on stretching the film at a high temperature.

The number average molecular weight of the polyester in the embodiment may be measured and evaluated by gel permeation chromatography (GPC). Specifically, a value obtained by the following method may be used: the polyester is dissolved in tetrahydrofuran (THF) and measured for polystyrene-conversion number average molecular weight with a high-pressure GPC, available from Tosoh Corporation. The number average molecular weight (Mn) is calculated in terms of polystyrene.

The polyester used in the embodiment is preferably synthesized from an acyclic aliphatic diol having from 2 to 10 carbon atoms and a dicarboxylic acid containing an alicyclic structure having from 3 to 12 carbon atoms, or from an aliphatic diol containing an alicyclic structure having from 2 to 10 carbon atoms and an acyclic aliphatic dicarboxylic acid having from 3 to 12 carbon atoms. As the synthesis method, known methods may be employed, such as dehydration condensation reaction of a dicarboxylic acid and a diol, addition and dehydration condensation reaction of a dicarboxylic acid anhydride to glycol.

The polyester is preferably a polyester oligomer that is obtained by synthesis with an aliphatic dicarboxylic acid as a dicarboxylic acid and a diol.

A dicarboxylic acid and a diol that are preferably used for synthesis of the polyester in the embodiment will be described.

### Dicarboxylic Acid

An aliphatic dicarboxylic acid may be used as the dicarboxylic acid.

Examples of the aliphatic dicarboxylic acid having a 3- to 6-membered alicyclic structure include 1,4-cyclohexanedicarboxylic acid, 3-methyl-1,4-cyclohexanedicarboxylic acid, cyclopropanedicarboxylic acid, 1,2-cyclobutanedicarboxylic acid, 1,3-cyclobutanedicarboxylic acid, 1,2-cyclopentanedicarboxylic acid, 1,3-cyclopentanedicarboxylic acid, 1,2-cyclohexanedicarboxylic acid, 1,3-cycohexanedicarboxylic acid and 1,4-cyclohexanedicarboxylic acid. Among these, 1,4-cyclohexanedicarboxylic acid and 3-methyl-1,4-cyclohexanedicarboxylic acid are preferred.

Examples of the acyclic aliphatic dicarboxylic acid include oxalic acid, malonic acid, succinic acid, maleic acid, fumaric acid, glutaric acid, adipic acid, suberic acid, azelaic acid, cyclohexanedicarboxylic acid and sebacic acid. Among these, succinic acid and adipic acid are preferred, and adipic acid is particularly preferred.

The dicarboxylic acid used in the embodiment preferably has from 3 to 12 carbon atoms, and more preferably from 4 to 8 carbon atoms. A mixture of two or more kinds of dicarboxylic acids may be used in the embodiment, and in this case, the average value of the number of carbon atoms of the two or more kinds of the dicarboxylic acids is preferably in the aforementioned range. When the number of carbon atoms of the dicarboxylic acid is in the range, the polyester may have high compatibility with the cellulose acylate, and the resulting optical film may be prevented from undergoing bleed out of the polyester in the production of the film and on stretching the film at a high temperature.

An acyclic aliphatic dicarboxylic acid and an aliphatic carboxylic acid having an alicyclic structure may be used in combination. Specific examples of the combination thereof include a combination of adipic acid and 1,4-cyclohexanedicarboxylic acid, and a combination of adipic acid and 3-methyl-1,4-cyclohexanedicarboxylic acid.

In the case where an acyclic aliphatic dicarboxylic acid and an aliphatic carboxylic acid having an alicyclic structure are used in combination, the molar ratio thereof m/n (wherein m represents the molar fraction of the repeating unit derived from the acyclic aliphatic dicarboxylic acid, and n represents the repeating unit derived from the aliphatic carboxylic acid having an alicyclic structure) is preferably from 0/10 to 3/7, and more preferably from 0/10 to 1/9.

### Diol

An aliphatic diol may be used as the diol.

Examples of the aliphatic diol having an alicyclic structure include 1,4-cyclohexanediol and 1,4-cyclohexanedimethanol.

Examples of the acyclic aliphatic diol include an alkanediol, specific examples of which include ethylene glycol, 1,2-propanediol, 1,3-propanediol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol(3,3-dimethylolpropane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol and diethylene glycol.

The aliphatic diol is preferably at least one kind of ethylene glycol, 1,2-propanediol and 1,3-propanediol, more preferably at least one kind of ethylene glycol and 1,2-propanediol, and particularly preferably ethylene glycol from the standpoint of the compatibility with the cellulose. In the case where two kinds of aliphatic diols are used, ethylene glycol and 1,2-propanediol are preferably used.

The glycol preferably has from 2 to 10 carbon atoms, more preferably from 2 to 6 carbon atoms, and particularly preferably from 2 to 4 carbon atoms. In the case where two or more kinds of the glycols are used, the average value of the number of carbon atoms of the two or more kinds of glycols is preferably in the aforementioned range. When the number of carbon atoms of the glycol is in the range, the polyester may have high compatibility with the cellulose acylate, and the resulting optical film may be prevented from undergoing bleed out of the polyester in the production of the film and on stretching the film at a high temperature.

### Substitution

The hydrogen atom of the hydroxyl terminal group of the polyester used in the embodiment is substituted by an acyl group derived from a monocarboxylic acid (which may be hereinafter referred to as a monocarboxylic acid residual group). The substitution of the hydrogen atom with the monocarboxylic acid residual group may be hereinafter referred to that the hydrogen atom of the hydroxyl terminal group is sealed. In this case, the polyester has at both terminals a monocarboxylic acid residual group. The substitution is effective for enhancing the polarizer durability used in a polarizing plate due to the factor that hydrolysis of the ester group may be delayed.

The residual group referred herein means a partial structure of the polyester that has characteristics of the monomer constituting the polyester. For example, the monocarboxylic acid residual group derived from a monocarboxylic acid R—COOH is R—CO—. The monocarboxylic acid residual group is preferably an aliphatic monocarboxylic acid residual group, more preferably an aliphatic monocarboxylic acid residual group having from 2 to 10 carbon atoms, further preferably an aliphatic monocarboxylic acid residual group having 2 or 3 carbon atoms, and particularly preferably an aliphatic monocarboxylic acid residual group having 2 carbon atoms.

When the number of carbon atoms of the monocarboxylic acid residual group at the both terminals of the polyester is 3 or less, the polyester may have low volatility to prevent the polyester from being reduced in amount, and the resulting optical film may be prevented from undergoing process contamination and malfunction in surface property. Accordingly, the monocarboxylic acid used for sealing is preferably an aliphatic monocarboxylic acid rather than an aromatic monocarboxylic acid, from the standpoint of the productivity and the surface quality. The monocarboxylic acid is preferably an aliphatic monocarboxylic acid having from 2 to 22 carbon atoms, more preferably an aliphatic monocarboxylic acid having 2 or 3 carbon atoms, and particularly preferably an aliphatic monocarboxylic acid having 2 carbon atoms. The monocarboxylic acid is preferably acetic acid, propionic acid, butanoic acid or a derivative thereof, more preferably acetic acid or propionic acid, and most preferably acetic acid (which forms a terminal acetyl group). Two or more kinds of the monocarboxylic acids may be used as a mixture for sealing.

In the case where the hydrogen atom of the hydroxyl terminal group is substituted by an acyl group derived from a monocarboxylic acid, the polyester may not be in a solid state at ordinary temperature to provide good handling property, and the resulting optical film may be excellent in the stability against humidity and the polarizer durability used in a polarizing plate.

The polyester preferably has a hydroxyl group value of 10 mgKOH/g or less, more preferably 5 mgKOH/g or less, and particularly preferably 0 mgKOH/g, from the standpoint of the enhancement of the polarizer durability.

### Synthesis Method

The polyester may be readily synthesized by a thermal melting condensation method with polyesterification reaction or ester exchange reaction of the diol and the monocarboxylic acid for sealing, or an interface condensation method of an acid chloride of the acid and the glycol.

### Addition Amount (Content)

The optical film of the embodiment preferably has a content of the polyester of from 5 to 20% by mass, more preferably from 5 to 18% by mas, and particularly preferably from 5 to 15% by mass, based on the cellulose ester. The polyester may be used solely or as a combination of two or more kinds thereof. In the case where two or more kinds thereof are contained, the total amount thereof is preferably in the aforementioned range.

### Ultraviolet Ray Absorbent

The optical film of the embodiment preferably contains an ultraviolet ray (UV) absorbent in addition to the cellulose ester as the major component. The UV absorbent contributes to improvement of the polarizer durability. In particular, the addition of the UV absorbent is effective in the case where the optical film of the embodiment is used as a surface protective film of a liquid crystal display device.

The UV absorbent that may be used in the embodiment is not particularly limited, and any UV absorbent that has been used in a cellulose acylate film may be used. Examples of the UV absorbent include those described in JP-A-2006-184874. A polymer ultraviolet ray absorbent may also be preferably used, and the polymer ultraviolet ray absorbent described in JP-A-6-148430 may be preferably used.

The amount of the ultraviolet ray absorbent used is not determined unconditionally since the amount may vary depending on the kind of the ultraviolet ray absorbent, the use conditions and the like, and the ultraviolet ray absorbent is preferably contained in an amount of from 1 to 3% by mass based on the cellulose acylate as the major component.

Examples of the ultraviolet ray absorbent include one having the following structure, but the ultraviolet ray absorbent added is not limited thereto.

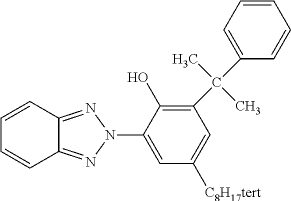

### Additional Additive

The optical film of the embodiment may further contain at least one kind of an additional additive in such a range that does not impair the advantageous effects of the invention. Examples of the additional additive include a polymer plasticizer except for the polyester containing the repeating unit represented by the formula (1) and having a terminal sealed with a monocarboxylic acid (for example, a phosphate ester plasticizer, a carboxylate ester plasticizer, a polycondensation oligomer plasticizer and the like), an ultraviolet ray absorbent, an antioxidant, and a matting agent described later.

The content of the additional additive contained in the optical film of the embodiment is preferably 3% by mass or less, and more preferably 1% by mass or less, based on the cellulose ester, and the additional additive is further preferably not contained.

The content of a retardation inducing agent (which includes a retardation reducing agent) in the optical film of the embodiment is preferably 3% by mass or less, and more preferably 1% by mass or less, based on the cellulose ester, and the retardation inducing agent is further preferably not contained.

### Additional Polymer Plasticizer

The optical film of the embodiment may contain an additional polymer plasticizer in such a range that does not impair the advantageous effects of the invention. Examples of the polymer plasticizer include a polyester polyurethane plasticizer, an aliphatic hydrocarbon polymer, an alicyclic hydrocarbon polymer, an acrylic polymer, such as a polyacrylate ester and a polymethacrylate ester (examples of the ester-forming group of which include a methyl group, an ethyl group, a propyl group, a butyl group, an isobutyl group, a pentyl group, a hexyl group, a cyclohexyl group, an octyl group, a 2-ethylhexyl group, a nonyl group, an isononyl group, a tert-nonyl group, a dodecyl group, a tridecyl group, a stearyl group, an oleyl group, a benzyl group and a phenyl group), a vinyl polymer, such as a polyvinyl isobutyl ether and poly-N-vinylpyrrolidone, a styrene polymer, such as polystyrene and poly-4-hydroxystyrene, a polyether, such as polyethylene oxide and polypropylene oxide, a polyamide, a polyurethane, a polyurea, a phenol-formaldehyde condensate, a urea-formaldehyde condensate, and vinyl acetate.

Among these, an acrylic polymer is preferably used in combination. In the embodiment, a homopolymer or a copolymer synthesized from a monomer, such as an alkyl acrylate or methacrylate ester, is preferred as the acrylic polymer.

Example of an acrylate ester monomer having no aromatic ring include methyl acrylate, ethyl acrylate, propyl (including isopropyl and n-propyl) acrylate, butyl (including n-butyl, isobutyl, s-butyl and t-butyl) acrylate, pentyl (including n-pentyl, isopentyl and s-pentyl) acrylate, hexyl (including n-hexyl and isohexyl) acrylate, heptyl (including n-heptyl and isoheptyl) acrylate, octyl (including n-octyl and isooctyl) acrylate, nonyl (including n-nonyl and isononyl) acrylate, myristyl (including n-myristyl and isomyristyl) acrylate, 2-ethylhexyl acrylate, ε-caprolactone acrylate, 2-hydroxyethyl acrylate, 2-hydroxypropyl acrylate, 3-hydroxypropyl acrylate, 4-hydroxybutyl acrylate, 2-hydroxybutyl acrylate, 2-methoxyethyl acrylate 2-ethoxyethyl acrylate, and compounds obtained by replacing the acrylate of the aforementioned compound by methacrylate. Examples of an acrylic monomer used for the acrylic polymer having an aromatic ring include styrene, methylstyrene and hydroxystyrene.

In the case where the acrylic polymer is a copolymer, the copolymer may contain an X component (a monomer component having a hydrophilic group) and a Y component (a monomer component having no hydrophilic group), and the molar ratio X/Y is preferably from 1/1 to 1/99. The content of the acrylic polymer is preferably from 1 to 20% by mass based on the cellulose ester. The acrylic polymer may be synthesized with reference, for example, to the method described in JP-A-2003-12859.

### Antioxidant

In the embodiment, a cellulose acylate solution may contain a known antioxidant, such as a phenol antioxidant and a hydroquinone antioxidant, e.g., 2,6-di-tert-butyl-4-methylphenol, 4,4′-thiobis(6-tert-butyl-3-methylphenol), 1,1′-bis(4-hydroxyphenyl)cyclohexane, 2,2′-methylenebis(4-ethyl-6-tert-butylphenol), 2,5-di-tert-butylhydroquinone and pentaerythritol tetrakis[3-(3,5-di-tert-butyl-4-hydroxyphenyl)propionate]. Furthermore, a phosphorous antioxidant may be preferably contained, such as tris(4-methoxy-3,5-diphenyl)phosphite, tris(nonylphenyl)phosphite, tris(2,4-di-tert-butylphenyl)phosphite, bis(2,6-di-tert-butyl-4-methylphenyl)pentaerythritol diphosphite and bis(2,4-di-tert-butylphenyl)pentaerythritol diphosphite. The amount of the antioxidant added is preferably from 0.05 to 5.0 parts by mass per 100 parts by mass of the cellulose ester.

### Production Method of Optical Film

The method for producing the optical film of the invention is not particularly limited, and the optical film may be produced by any known method. Examples of the production method include a solution casting film forming method and a melt film forming method. For enhancing the surface property of the optical film, the optical film is preferably produced by a solution casting film forming method. An embodiment where the optical film is produced by a solution casting film forming method will be described below, but the invention is not limited to a solution casting film forming method. For producing the optical film by a melt casting method, any known method may be used.

### Polymer Solution

In the solution casting film forming method, a solution containing the cellulose ester, the polyester and the various additives depending on necessity (i.e., a cellulose ester solution) is used for forming a web. The polymer solution that may be used in the solution casting film forming method (which may be hereinafter referred to as a cellulose acylate solution) will be described below.

### Solvent

The cellulose ester used in the embodiment is dissolved in a solvent to form a dope, which is then cast on a substrate to form a film. It is necessary in this case to evaporate the solvent after extrusion or casting, a volatile solvent is preferably used.

The solvent is preferably such a solvent that does not undergo reaction with a reactive metal compound, a catalyst and the like, and does not dissolve the substrate for casting. Two or more kinds of solvents may be used in combination.

The cellulose ester and a reactive metal compound may be dissolved in separate solvents respectively, and the resulting solution may be mixed with each other.

An organic solvent that has good solubility is referred to as a good solvent, and a solvent that exhibits major effect of dissolution and is used in a large amount is referred to as a major (organic) solvent.

Examples of the good solvent include a ketone compound, such as acetone, methyl ethyl ketone, cyclopentanone and cyclohexanone, an ether compound, such as tetrahydrofuran (THF), 1,4-dioxane, 1,3-dioxolane and 1,2-dimethoxyethane, and an ester compound, such as methyl formate, ethyl formate, methyl acetate, ethyl acetate, amyl acetate and 7-butyrolactone, and also include methyl cellosolve, dimethylimidazoline, dimethylformamide, dimethylacetamide, acetonitrile, dimethylsulfoxide, sulfolane, nitroethane, methylene chloride and methyl acetoacetate, and 1,3-dioxolane, THF, methyl ethyl ketone, acetone, methyl acetate and methylene chloride are preferred.

The dope preferably contains an alcohol having from 1 to 4 carbon atoms in an amount of from 1 to 40% by mass in addition to the organic solvent.

The alcohol may be used as a gelation solvent, in which after casting the dope on a metal support, the web (a dope film obtained by casting the dope of the cellulose acylate may be referred to as a web) is gelled by increasing the proportion of the alcohol due to evaporation of the solvent, thereby facilitating the release of the web from the metal support, and in the case where the proportion of the alcohol is small, the alcohol may accelerate the dissolution of the cellulose acylate in a non-chlorine organic solvent, and also suppresses a reactive metal compound from being gelled, deposited and increased in viscosity.

Examples of the alcohol having from 1 to 4 carbon atoms include methanol, ethanol, n-propanol, isopropanol, n-butanol, sec-butanol, tert-butanol and propylene glycol monomethyl ether.

Among these, methanol and ethanol are preferred since they have a relatively low boiling point and good drying property, and have no toxicity. The most preferred is ethanol. This kind of organic solvents has no dissolution power to the cellulose ester by itself and thus is referred to as a poor solvent.

The cellulose ester as a raw material of the cellulose ester in the embodiment contains a hydrogen bonding functional group, such as a hydroxyl group, an ester group and a ketone group, and thus the alcohol is preferably contained in the total solvent in an amount of from 5 to 30% by mass, more preferably from 7 to 25% by mass, and further preferably from 10 to 20% by mass, for reducing the releasing load from the casting support.

In the embodiment, water may be contained in a small amount, which is effective for enhancing the viscosity of the solution and the wet web strength on drying, and for enhancing the dope strength on drum casting. For example, water may be contained in an amount of from 0.1 to 5% by mass, preferably from 0.1 to 3% by mass, and particularly preferably from 0.2 to 2% by mass.

Preferred examples of the combination of organic solvents used as the solvent for the polymer solution in the embodiment include those described in JP-A-2009-262551.

A non-halogen organic solvent may be used as the major solvent depending on necessity, the details of which are described in JIII Journal of Technical Disclosure Monthly, 2001-1745, Mar. 15, 2001.

The concentration of the cellulose ester in the polymer solution in the embodiment is preferably from 5 to 40% by mass, more preferably from 10 to 30% by mass, and most preferably from 15 to 30% by mass.

The concentration of the cellulose ester may be controlled to the prescribed concentration in the stage where the cellulose ester is dissolved in the solvent. Alternatively, a solution having a low concentration (for example, from 4 to 14% by mass) may be prepared in advance and then concentrated by evaporating the solvent. A solution having a high concentration may be prepared in advance and the diluted. The concentration of the cellulose ester may be lowered by adding the additive.

The stage where the additive is added may be appropriately determined depending on the kind of the additive. For example, an aromatic ester oligomer and a UV absorbent may be dissolved in an organic solvent, such as an alcohol, e.g., methanol, ethanol and butanol, methylene chloride, methyl acetate, acetone and dioxolane, or a mixed solvent thereof, and then added to the dope, or may be added directly to the dope. A material that is not dissolved in an organic solvent, such as an inorganic powder material, may be dispersed in an organic solvent and the cellulose ester with a dissolver or a sand mill, and then added to the dope.

Examples of the solvent that is most suitable for dissolving the cellulose ester in a high concentration include a mixed solvent of methylene chloride and ethyl alcohol in a ratio of from 95/5 to 80/20, and a mixed solvent of methyl acetate and ethyl alcohol in a ratio of from 60/40 to 95/5.

### (1) Dissolving Step

In this step, the cellulose ester and the additive are dissolved in an organic solvent mainly containing a good solvent in a dissolving tank to form a dope, or the cellulose ester solution and the additive solution are mixed to form a dope.

Examples of the method for dissolving the cellulose ester include a method of dissolving under ordinary pressure, a method of dissolving at a temperature lower than the boiling point of the major solvent, a method of dissolving under pressure at a temperature higher than the boiling point of the major solvent, a cooling dissolving method described in JP-A-9-95544, JP-A-9-95557 and JP-A-9-95538, and a method of dissolving under high pressure described in JP-A-11-21379, and a method of dissolving under pressure at a temperature higher than the boiling point of the major solvent is preferably employed.

The concentration of the cellulose ester in the dope is preferably from 10 to 35% by mass. After the additive is added, dissolved and dispersed in the dope after or during the dissolution of the cellulose ester, the dope is preferably filtered with a filter, deaerated and then fed to the next step with a liquid feed pump.

### (2) Casting Step

In this step, the dope is fed to a pressure die with a liquid feed pump (such as a pressure metering pump) and cast through the slit of the pressure die onto a casting position of a metal support, such as an endlessly running endless metal belt, e.g., a stainless steel belt, or a rotating metal drum.

The pressure die preferably has at the top thereof a slit capable of being adjusted in the shape thereof for controlling the film thickness uniformly. Examples of the pressure die include a coat hanger die and a T-die, any of which may be preferably used. The metal support has a mirror surface. For enhancing the film forming speed, two or more pressure dies may be provided on the metal support, to which the amount of the dope is distributed, and plural dope films may be laminated. Alternatively, a film having a laminate structure is preferably obtained by a co-casting method, in which plural dopes are cast simultaneously.

### (3) Solvent Evaporating Step

In this step, the web (which is a precursor of the completed optical film and contains a large amount of the solvent) is heated on the metal support, thereby evaporating the solvent to such an extent that the web is capable of being released from the metal support.

For evaporating the solvent, such a method may be employed as a method of blowing air from the side of the web, a method of conducting heat with a liquid from the back surface of the metal support, a method of conducting heat by radiation on both the front and back surface thereof, and the like, and a method of conducting heat with a liquid from the back surface is preferred due to the good drying efficiency obtained thereby. Combinations of these methods may also be preferably employed. In the method of conducting heat with a liquid from the back surface, the metal support is preferably heated to a temperature that is lower than the boiling point of the major solvent of the organic solvents used in the dope or the boiling point of the organic solvent having the lowest boiling point therein.

### (4) Releasing Step

In this step, the web, from which the solvent has been evaporated on the metal support, is released therefrom at a releasing position. The web thus released is sent to the next step. When the residual solvent amount (see the expression below) of the web on releasing is too large, it may be difficult to release the web, and when the web has been dried excessively on the metal support, the web may be broken partly on releasing.

A gel casting method may be employed as a method of enhancing the film forming speed (the film forming speed may be increased by releasing at a large residual solvent amount as much as possible. Examples of the gel casting method include a method of adding a poor solvent to the cellulose ester to the dope, and gelling the dope after casting the dope, and a method of gelling the dope by decreasing the temperature of the metal support. The dope film may be increased in strength by gelling on the metal support, thereby facilitating the release and increasing the film forming speed.

The residual solvent amount on releasing the web from the metal support is preferably in a range of from 5 to 150% by mass while depending on the strength of the drying condition, the length of the metal support and the like, and in the case where the web is released at a larger residual solvent amount, the residual solvent amount on releasing may be determined in consideration of the economical speed and the quality. In the embodiment, the temperature of the metal support at the releasing position is preferably from −50 to 40° C., more preferably from 10 to 40° C., and most preferably from 15 to 30° C.

The residual solvent amount of the web at the releasing position is preferably from 10 to 150% by mass, and more preferably from 10 to 120% by mass.

The residual solvent amount is expressed by the following expression.

residual solvent amount (% by mass)=((M−N)/N)×100

wherein M represents the mass of the web at an arbitrary time point, and N represents the mass of the web having the mass M that has been dried at 110° C. for 3 hours.

### (5) Drying or Heat-Treating Step and Stretching Step

After the releasing step, the web is preferably dried with a drying device, in which the web is passed through plural rolls alternately, and/or a tenter device, in which the web is conveyed with both ends thereof held with a clip.

In the case where the web is heat-treated in the embodiment, the heat treatment temperature may be less than (Tg−5° C.), preferably (Tg−20° C.) or more and less than (Tg−5° C.), and more preferably (Tg−15° C.) or more and less than (Tg−5° C.).

The heat treatment time is preferably 30 minutes or less, more preferably 20 minutes or less, and particularly preferably approximately 10 minutes.

The measure for drying and heat-treating the web may be generally hot air blown on the web, or may be microwave applied thereto instead of hot air. The temperature, the air flow amount and the time may vary depending on the solvent used, and the conditions may be appropriately selected depending on the kind and the combination of the solvent.

The web may be stretched in any one direction of the machine direction (MD) and the transversal direction (TD) or may be biaxially stretched in both the directions. The web is preferably biaxially stretched. The stretching may be performed by a single step or multiple steps. The tensile elastic modulus may be controlled to the aforementioned range by controlling the kind of the cellulose acylate and the acylation degree thereof, and selecting the additives and controlling the proportions thereof.

The stretching ratio in MD, i.e., the film conveying direction, is preferably from 0 to 20%, more preferably from 0 to 15%, and particularly preferably from 0 to 10%. The stretching ratio (i.e., elongation) of the web on stretching may be achieved by the difference in circumferential speed between the metal support and the releasing speed (e.g., the drawing speed of releasing roll). For example, in the case where an equipment having two nip rolls is used, the rotation speed of the nip roll on the side of outlet is rendered larger than the rotation speed of the nip roll on the side of inlet, thereby stretching the film favorably in the conveying direction, i.e., MD. The tensile elastic modulus in MD may be controlled by performing the stretching.

The stretching ratio (%) referred herein means a value defined by the following expression.

stretching ratio (%)=100×((length after stretching)−(length before stretching))/(length before stretching)

The stretching ratio in TD, i.e., the direction perpendicular to the film conveying direction, is preferably from 0 to 30%, more preferably from 1 to 20%, and particularly preferably from 2 to 15%.

In the embodiment, the web is preferably stretched in TD, i.e., the direction perpendicular to the film conveying direction, with a tenter device.

In the biaxial stretching, the web may be relaxed, for example, by from 0.8 to 1.0 time in MD to provide a desired retardation value. The stretching ratio may be determined depending on various purposes. The optical film may be uniaxially stretched in MD in production.

The temperature on stretching is preferably Tg or less, thereby increasing the tensile elastic modulus in the stretching direction. The stretching temperature is preferably from (Tg−50° C.) to Tg, and more preferably from (Tg−30° C.) to (Tg−5° C.). When the web is stretched at a temperature within the range, there is a tendency that the tensile elastic modulus in the stretching direction is increased, whereas the tensile elastic modulus in the direction perpendicular thereto is decreased. Accordingly, for increasing the tensile elastic modulus in both MD and TD, the web is preferably stretched in both the directions, i.e., biaxially stretched, at a temperature within the range.

The web may be dried after stretching. In the case where the web is dried after the stretching step, the drying temperature, the drying airflow amount and the drying time may vary depending on the solvent used, and the drying condition may be appropriately selected depending on the kind of the solvent and the combination thereof. In the embodiment, the drying temperature after the stretching step is preferably lower than the stretching temperature in the stretching step for increasing the front contrast on installing the film in a liquid crystal display device.

### (6) Winding Step

The thus resulting film is preferably wound in a length of from 100 to 10,000 m, more preferably from 500 to 7,000 m, and further preferably from 1,000 to 6,000 m, per roll. The width of the film is preferably from 0.5 to 5.0 m, more preferably from 1.0 to 3.0 m, and further preferably from 1.0 to 2.5 m. On winding the film, the film is preferably subjected to knurling on at least one edge thereof, and the knurling preferably has a width of from 3 to 50 mm, and more preferably from 5 to 30 mm, and a height of from 0.5 to 500 and more preferably from 1 to 200 The knurling may be single wheel knurling or double wheel knurling.

The thus obtained web is wound to complete the optical film.

### Layer Structure

The optical film having a functional layer described later may be also referred to as an optical film inclusively with the functional layer, and the optical film except for the functional layer may be referred to as a film containing a cellulose ester. The optical film of the invention (i.e., the film containing a cellulose ester) may be a single layer film or may have a laminated layer structure including two or more layers. For example, the optical film preferably has a laminated layer structure containing two layers, a core layer and an outer layer (which may also be referred to as a surface layer or a skin layer), or a laminated layer structure containing three layers, an outer layer, a core layer and an outer layer. The laminated layer structure is preferably produced by co-casting.

In the case where the optical film of the invention has a laminated layer structure containing two or more layers, the outer layer preferably contains a matting agent. Examples of the matting agent used include those described in JP-A-2011-127045, and for example, silica particles having an average particle size of 20 nm may be used.

### Thickness of Optical Film

The thickness of the optical film is from 10 to 45 μm, preferably from 15 to 35 μm, and more preferably from 15 to 32 μm.

### Elastic Modulus of Optical Film

The elastic modulus (tensile elastic modulus) of the optical film is 4.2 GPa or more, preferably 4.3 GPa or more, and more preferably 4.5 GPa or more. The upper limit of the elastic modulus is not particularly limited and is generally 10 GPa or less. When the elastic modulus is 4.2 GPa or more, the film may have an enhanced rigidity.

The elastic modulus may be measured in such a manner that the stress at an elongation of 0.5% is measured with a versatile tensile tester “STM T50BP”, available from Baldwin Japan, Ltd., at a tensile speed of 10% per minute at 23° C. and 60% RH, and the average value of the tensile elastic moduli in MD and TD is designated as the tensile elastic modulus.

### Optical Characteristics of Optical Film

The in-plane retardation (Re) at a wavelength of 590 nm under an environment of 25° C. and 60% RH of the optical film is preferably from −5 to 5 nm, more preferably from 0 to 5 nm, and further preferably from 0 to 3 nm.

The retardation in thickness direction (Rth) at a wavelength of 590 nm under an environment of 25° C. and 60% RH of the optical film is preferably from −5 to 5 nm, more preferably from −3 to 5 nm, and further preferably 0 to 5 nm.

The values Re(λ) and Rth(λ) herein mean the in-plane retardation and the retardation in thickness direction, respectively, at a wavelength λ. The wavelength λ herein is 590 nm unless otherwise indicated. Re(λ) may be measured with KOBRA 21ADH (available from Oji Scientific Instruments Co., Ltd.) by making light having a wavelength of λ nm incident in the normal line direction of the film. Rth (λ) may be obtained in such a manner that Re(λ) is measured for 6 points by making light having a wavelength of λ nm incident at angles of from the normal line direction to 50° for each ends with a step of 10° with the in-plane retardation axis being the tilting axis (rotation axis) (when there is no retardation axis, an arbitrary direction within the plane of the film is designated as the rotation axis), and Rth (λ) is calculated with KOBRA 21ADH based on the retardation values thus measured, the assumed value of the average refractive index and the thickness of the film thus input. Rth may also be obtained in such a manner that retardation values are measured in arbitrary two directions with the retardation axis being the tilting axis (rotation axis) (when there is no retardation axis, an arbitrary direction within the plane of the film is designated as the rotation axis), and Rth is calculated from the following expressions (A) and (B) based on the retardation values thus measured, the assumed value of the average refractive index and the thickness of the film thus input. The assumed value of the average refractive index used herein may be values shown in Polymer Handbook (John Wiley & Sons, Inc.) and catalogs of various optical films. For a film with no known average refractive index, the refractive index thereof may be measured with an Abbe refractometer. The average refractive indices of major optical films are shown below: cellulose acylate (1.48), cycloolefin polymer (1.52), polycarbonate (1.59), polymethyl methacrylate (1.49) and polystyrene (1.59). KOBRA 21ADH calculates nx, ny and nz based on the assumed value of the average refractive index and the thickness of the film thus input, and based on nx, ny and nz, Nz=(nx−nz)/(nx−ny) is further calculated.

$$\begin{matrix}Re ( θ ) = [ nx - \frac{( ny \times nz )}{( \sqrt{\begin{matrix}{\{ ny sin ( {sin}^{- 1} ( \frac{sin ( - θ )}{nx} ) ) \}}^{2} + \\ {\{ nz cos ( {sin}^{- 1} ( \frac{sin ( - θ )}{nx} ) ) \}}^{2}\end{matrix}} )} ] \times \frac{d}{cos \{ {sin}^{- 1} ( \frac{sin ( - θ )}{nx} ) \}} & Expression ( A ) \\ Rth = ( ( nx + ny ) / 2 - nz ) \times d & Expression ( B )\end{matrix}$$

wherein Re(θ) represents the retardation value in the direction that is tilted from the normal line direction by an angle θ, nx, ny and nz represent the refractive indices of the index ellipsoid in the main axis azimuths respectively, and d represents the thickness of the film.

### Purpose of Optical Film

The optical film of the invention is useful as various purposes including a protective film for a polarizing plate, a surface protective film disposed on an image display surface, and the like. For imparting functions suitable for the purposes, the optical film may have, for example, a hardcoat layer, an antiglare layer, a clear hardcoat layer, an antireflection layer, an antistatic layer and an antifouling layer.

The optical film of the invention contains the film containing the cellulose ester, and thus has good adhesion property to a polarizer, and therefore the optical film is suitable for the use in a liquid crystal display device having a polarizing plate as an essential member.

The protective film for a polarizing plate used on the front side of the display device preferably has an antiglare layer and a clear hardcoat layer, and also an antireflection layer, an antistatic layer and an antifouling layer.

In the production of a polarizing plate with the optical film of the invention that has an in-plane retardation axis, the optical film is preferably adhered in such a manner that the in-plane retardation axis is in parallel to or perpendicular to the transmission axis of the polarizer.

### Polarizing Plate

The invention also relates to polarizing plate containing at least one sheet of the optical film according to the invention. The polarizing plate according to the invention preferably contains the optical film of the invention and a polarizer.

The polarizing plate of the invention may be produced by an ordinary method. For example, the polarizing plate may be produced by adhering a polarizer on one surface of the optical film of the invention. The adhesion surface of the optical film is preferably subjected to an alkali saponification treatment. A fully saponified polyvinyl alcohol aqueous solution may be used for the adhesion.

The polarizer used in the polarizing plate may be any ordinary one. Examples thereof include a polarizer obtained by treating a film formed of a hydrophilic polymer, such as polyvinyl alcohol or ethylene-modified polyvinyl alcohol having an ethylene unit content of from 1 to 4% by mol, a polymerization degree of from 2,000 to 4,000 and a saponification degree of from 99.0 to 99.99% by mol, with a dichroic dye, such as iodine, followed by stretching, and a polarizer obtained by treating and orienting a plastic film, such as polyvinyl chloride.

The thickness of the polarizer is preferably from 5 to 30 μm. The polarizer thus obtained is adhered to the optical film of the invention.

On the surface of the polarizer opposite to the surface having the optical film of the invention adhered, another optical film according to the invention may be adhered, or a known optical film may be adhered.

While the known optical film used is not limited in the optical characteristics and the material thereof, optical films formed of an acrylic resin and a cyclic olefin resin may be preferably used, and both an optically isotropic film and an optically anisotropic retardation film may be used.

Examples of the known optical film that is formed of an acrylic resin include the optical film formed of a (meth)acrylic resin containing a styrene resin described in Japanese Patent No. 4,570,042, the optical film formed of a (meth)acrylic resin having a glutarimide ring structure in the main chain thereof described in Japanese Patent No. 5,041,532, the optical film formed of a (meth)acrylic resin having a lactone ring structure described in JP-A-2009-122664, and the optical film formed of a (meth)acrylic resin having a glutaric anhydride unit described in JP-A-2009-139754.

Examples of the known optical film that is formed of a cyclic olefin resin include the cyclic olefin resin film described in JP-A-2009-237376, paragraphs 0029 et seq., and the cyclic olefin resin film containing an additive that reduces Rth described in Japanese Patent No. 4,881,827 and JP-A-2008-063536.

In an embodiment where the polarizing plate according to the invention is used in a liquid crystal display device, both cases may be preferred where the optical film of the invention is disposed on the inner side of the polarizer (i.e., between the polarizer and the liquid crystal cell) and on the outer side of the polarizer (i.e., on the side of the polarizer opposite to the liquid crystal cell), and the optical film of the invention is preferably disposed between the polarizer and the liquid crystal cell.

### Liquid Crystal Display Device

The invention also relates to a liquid crystal display device having the optical film according to the invention or the polarizing plate according to the invention. The function of the optical film of the invention in the liquid crystal display device is not particularly limited. One example of the position where the optical film of the invention is disposed is a surface protective film of a polarizing plate disposed on the side of the backlight of the liquid crystal display device having no hardcoat layer, in which the surface protective film is disposed between the polarizer and the liquid crystal cell (i.e., on the surface of the polarizer on the side of the liquid crystal cell). Another example of the position where the optical film of the invention is disposed is a surface protective film of a polarizing plate disposed on the side of the display surface of the liquid crystal display device having no hardcoat layer, in which the surface protective film is disposed between the polarizer and the liquid crystal cell (i.e., on the surface of the polarizer on the side of the liquid crystal cell).

The other structures and materials of the liquid crystal display device may be ones that are known for known liquid crystal display devices. The display mode of the liquid crystal display device is not particularly limited, and liquid crystal display devices having various display modes are included, such as TN (twisted nematic), IPS (in-plane switching), FLC (ferroelectric liquid crystal), AFLC (anti-ferroelectric liquid crystal), OCB (optically compensatory bend), STN (super twisted nematic), VA (vertically aligned) and HAN (hybrid aligned nematic), with a liquid crystal display device having an IPS mode being preferred.

### EXAMPLES

The features of the invention will be described in more detail with reference to examples below. The materials, the amounts and ratios thereof used, the contents of processes, the procedures of processes, and the like in the examples may be modified as far as they do not deviate from the substance of the invention. Accordingly, the invention is not construed as being limited to the following examples.

### Example 1

### Production of Core Layer Cellulose Acylate Dope

The following components were dissolved by agitating in a mixing tank to prepare a cellulose acetate solution.

| | |
|---|---|
| Cellulose acetate having acetylation degree of 2.88 | 100 parts by mass |
| Ester oligomer A | 13 parts by mass |
| Methylene chloride (first solvent) | 430 parts by mass |
| Methanol (second solvent) | 64 parts by mass |

The oligomers used are shown in Table 1 below.

TABLE 1

| | Molar fraction (%) | | | | | | | |
|---|---|---|---|---|---|---|---|---|
| | Dibasic acid | | | Diol | | | Terminal | |
| Oligomer | 1,4-CHA | 3Me-1,4-CHA | AA | EG | PG | Mn | structure | Note |
| A | 50 | 0 | 0 | 50 | 0 | 1,000 | AcO | invention |
| B | 0 | 50 | 0 | 50 | 0 | 850 | AcO | invention |
| C | 30 | 20 | 0 | 50 | 0 | 920 | AcO | invention |
| D | 50 | 0 | 0 | 40 | 10 | 900 | AcO | invention |
| E | 45 | 0 | 5 | 50 | 0 | 1,150 | AcO | invention |
| F | 0 | 0 | 50 | 50 | 0 | 1,000 | AcO | comparison |
| G | 50 | 0 | 0 | 50 | 0 | 1,000 | OH | comparison |

The abbreviations in Table 1 have the following meanings.

1,4-CHA: 1,4-cyclohexanedicarboxylic acid
3Me-1,4-CHA: 3-methyl-1,4-cyclohexanedicarboxylic acid
AA: adipic acid
EG: ethylene glycol
PG: propylene glycol
Mn: number average molecular weight
AcO: terminal structure sealed with an acetyl group
OH: hydroxyl group

### Production of Outer Layer Cellulose Acylate Dope

10 parts by mass of a matting agent solution shown below was added to 90 parts by mass of the core layer cellulose acylate dope produced above to prepare an outer layer cellulose acetate solution.

| | | |
|---|---|---|
| Silica particles (average particle diameter: 20 nm, | 2 | parts by mass |
| Aerosil R972, available from Nippon Aerosil Co., | | |
| Ltd. | | |
| Methylene chloride (first solvent) | 76 | parts by mass |
| Methanol (second solvent) | 11 | parts by mass |
| Core layer cellulose acylate dope | 1 | part by mass |

### Production of Optical Film

The polymer solutions each were filtered with filter paper having an average pore diameter of 34 μm and a sintered metal filter having an average pore diameter of 10 μm, and cast simultaneously for three layers from the casting outlets onto a drum at 20° C. (band casting machine) in such a manner that the outer layer cellulose acylate dope was cast on both sides of the core layer cellulose acylate dope. The film was released in the state where the solvent content thereof was 20% by mass, and the film was dried while stretching by 1.1 times with both edges of the film being fixed with tenter clips. Thereafter, the film was further dried by conveying among rolls of a heat treatment device, thereby producing an optical film having a thickness of 25 μm, which was designated as an optical film of Example 1.

### Examples 2 to 11, Reference Example and Comparative Examples 1 to 4

Optical films of Examples 2 to 11, Reference Example and Comparative Examples 1 to 4 were produced in the same manner as in the production of the optical film of Example 1 except that the kind and the amount of the polyester used in the optical film and the thickness of the film were changed as shown in Table 2.

The optical film of Reference Example was excellent in the optical performance, the elastic modulus, the dent bump and the polarizer durability, but the optical film had an increased thickness of 50 μm and thus was difficult to solve the problem to be solved by the invention.

### Evaluation

The optical films of Examples, Reference Example and Comparative Examples were subjected to the following evaluation. The results of the evaluation are shown in Table 2.

### Measurement of Optical Performance

The optical films of Examples, Reference Example and Comparative Examples each were measured for retardation at a wavelength of 590 nm under an environment of 25° C. and 60% RH with KOBRA 21ADH (available from Oji Scientific Instruments Co., Ltd.). The results of the evaluation are shown in Table 2.

### Measurement of Elastic Modulus

The optical films of Examples, Reference Example and Comparative Examples each were measured for elastic modulus in such a manner that the stress at an elongation of 0.5% was measured with a versatile tensile tester “STM T50BP”, available from Baldwin Japan, Ltd., at a tensile speed of 10% per minute at 23° C. and 60% RH, and the average value of the tensile elastic moduli in MD and TD was designated as the elastic modulus. The results of the evaluation are shown in Table 2.

### Evaluation of Dent Bump

The optical films of Examples, Reference Example and Comparative Examples each were rolled into a roll having a length of 3,900 m, which was allowed to stand for one week and then visually observed for the appearance thereof with the following standard. The results of the evaluation are shown in Table 2.

A: The roll was free of deformation.
B: The roll suffered a dent bump on the surface thereof.

### Production of Polarizing Plate

### (1) Saponification of Film

The optical films of Examples, Reference Example and Comparative Examples and Fujitac TD40UC (available from Fujifilm Corporation) each were immersed in a 4.5 mol/L sodium hydroxide aqueous solution (saponification solution) controlled to 37° C. for 1 minute, washed with water, subsequently immersed in a 0.05 mol/L sulfuric acid aqueous solution for 30 seconds and then rinsed in a water bath. The films each were dehydrated by subjecting to draining with an air knife three times, and then dried by retaining in a drying zone at 70° C. for 15 seconds, thereby producing saponified films.

### (2) Production of Polarizer

The film was stretched in the machine direction by passing through two pairs of nip rolls, to which a difference in circumferential speed was applied, according to Example 1 of JP-A-2001-141926, thereby preparing a polarizing film having a thickness of 20 μm.

### (3) Adhesion

Two sheets were selected from the aforementioned saponified films and were disposed on both sides of the polarizing film, and the films were adhered to each other by a roll-to-roll process with a 3% PVA aqueous solution (PVA-117H, available from Kuraray Co., Ltd.) as an adhesive in such a manner that the polarizing axis of the polarizing film was perpendicular to the machine direction of the saponified films, thereby producing a polarizing plate. In the polarizing plate, the film on one side of the polarizing film was one selected from the saponified films obtained by saponifying the optical films of Examples, Reference Example and Comparative Examples, and the film on the other side of the polarizing film was the film obtained by saponifying Fujitac TD40UC.

### Evaluation of Polarizer Durability

The polarizing plates thus produced above each were adhered on the side of the optical films of Examples, Reference Example and Comparative Examples to a glass plate with a pressure-sensitive adhesive, thereby preparing two pairs of specimens each having a size of approximately 5 cm×5 cm. The specimens were disposed to form crossed nicols, which were measured for crossed nicols transmittance at a wavelength of 410 nm with an automatic polarizing film measuring machine, VAP-7070, available from Jasco Corporation. Thereafter, the specimens having been stored under an environment of 60° C. and 95% RH for 400 hours were measured for crossed nicols transmittance in the same manner as above. The polarizer durability of the polarizing plate is defined by the change rate of the crossed nicols transmittance as follows.

evaluation value of polarizer durability of polarizing plate=((crossed nicols transmittance after storing (%))−(crossed nicols transmittance before storing (%)))/(crossed nicols transmittance before storing (%))

The polarizing plate is free of any practical problem when the evaluation value of the polarizer durability of the polarizing plate is 40 or less, and the evaluation value of the polarizer durability is preferably 30 or less, and more preferably 27 or less.

The results obtained are shown in Table 2.

TABLE 2

| | | | | | | | | | Optical | | | | |
|---|---|---|---|---|---|---|---|---|---|---|---|---|---|
| | | | | | | | | Thickness | performance | | Elastic | | |
| | Polyester (part by mass) | | | | | | | of film | (nm) | | modulus | Dent | Polarizer |
| | A | B | C | D | E | F | G | (μm) | Re | Rth | (GPa) | bump | durability * |
| Example 1 | 13 | | | | | | | 25 | 0 | 1 | 4.7 | A | 29 |
| Example 2 | 15 | | | | | | | 25 | 0 | 0 | 4.8 | A | 32 |
| Example 3 | | 11 | | | | | | 25 | 0 | 3 | 4.7 | A | 26 |
| Example 4 | 6 | 6 | | | | | | 25 | 0 | 2 | 4.7 | A | 27 |
| Example 5 | | | 10 | | | | | 25 | 0 | 3 | 4.6 | A | 25 |
| Example 6 | | | | 13 | | | | 25 | 0 | 1 | 4.7 | A | 29 |
| Example 7 | | | | | 12 | | | 25 | 0 | 2 | 4.7 | A | 27 |
| Example 8 | 10 | | | | | 3 | | 25 | 0 | 0 | 4.7 | A | 33 |
| Example 9 | 12 | | | | | | | 20 | 0 | 0 | 4.8 | A | 22 |
| Example 10 | | 15 | | | | | | 32 | 0 | 0 | 4.7 | A | 36 |
| Example 11 | | | 9 | | | | | 32 | 0 | 4 | 4.5 | A | 28 |
| Comparative | | | | | | 7 | | 25 | 0 | 8 | 4.3 | A | 21 |
| Example 1 | | | | | | | | | | | | | |
| Comparative | | | | | | 10 | | 25 | 0 | 2 | 4.0 | B | 25 |
| Example 2 | | | | | | | | | | | | | |
| Comparative | | | | | | 15 | | 32 | 0 | −3 | 3.7 | B | 25 |
| Example 3 | | | | | | | | | | | | | |
| Comparative | | | | | | | 15 | 25 | 0 | 0 | 4.8 | A | 42 |
| Example 4 | | | | | | | | | | | | | |
| Reference | 13 | | | | | | | 50 | 0 | 2 | 4.7 | A | 41 |
| Example | | | | | | | | | | | | | |

Note:
* Polarizer durability, change rate of crossed nicols transmittance

The optical films of Examples 1 to 11, Comparative Examples 1 and 4 and Reference Example were free of dent bump due to the high elastic modulus of the films, but the optical films of Comparative Examples 2 and 3 suffered dent bump after storing in the form of a roll for one week due to the low elastic modulus of the films.

The optical films of Comparative Example 4 and Reference Example suffered a large change in crossed nicols transmittance after storing and were reduced in contrast. The optical films of Examples 1 to 11 according to the invention had high polarizer durability and were suppressed in reduction of contrast as compared to the optical films of Comparative Example 4 and Reference Example.

### Evaluation on Mounting in IPS Liquid Crystal Display Device

In commercially available liquid crystal television sets (an IPS mode low-profile 42-inch liquid crystal television set), the polarizing plates holding the liquid crystal cell were peeled off from the liquid crystal cell, and the polarizing plates produced above each were adhered again with a pressure-sensitive adhesive to the liquid crystal cell with the side of the optical films of Examples, Reference Example and Comparative Examples shown in Table 2 directed to the side of the liquid crystal cell. The thus refabricated television sets each were evaluated for the display characteristics by observing the luminance and the color tone from the front and the diagonal direction. In the polarizing plate produced by using the optical film of Comparative Example 1, the color tone was largely changed on viewing from the diagonal direction, and thus the polarizing plate had poor display characteristics. In the polarizing plates produced by using the optical films of Examples 1 to 11, Comparative Examples 2 to 4 and Reference Example showed display characteristics that were equivalent to the original polarizing plate of the television set.

While the present invention has been described in detail and with reference to specific embodiments thereof, it will be apparent to one skilled in the art that various changes and modifications can be made therein without departing from the spirit and scope thereof.

The present disclosure relates to the subject matter contained in Japanese Patent Application No. 2013-146337, filed on Jul. 12, 2013, the contents of which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

What is claimed is:

1. An optical film comprising:
a cellulose ester and
at least one kind of a polyester containing an alicyclic structure and having a hydroxyl terminal group, a hydrogen atom of which is substituted by an acyl group derived from a monocarboxylic acid, and
having:
a thickness of from 10 to 45 μm,
an in-plane retardation Re at a wavelength of 590 nm under an environment of 25° C. and 60% RH of from −5 to 5 nm,
a retardation in thickness direction Rth at a wavelength of 590 nm under an environment of 25° C. and 60% RH of from −5 to 5 nm, and
an elastic modulus of 4.2 GPa or more.

2. The optical film according to claim 1, wherein the polyester has a number average molecular weight Mn of from 500 to 3,000.

3. The optical film according to claim 1, wherein the polyester is derived from a polymer of an acyclic aliphatic diol and a dicarboxylic acid having an alicyclic structure, or a polymer of an aliphatic diol having an alicyclic structure and an acyclic aliphatic dicarboxylic acid.

4. The optical film according to claim 1, wherein the polyester contains a repeating unit represented by the following formula (1): 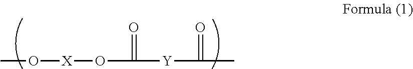
wherein X represents an acyclic divalent linking group having from 2 to 10 carbon atoms, and Y represents a linking group having from 3 to 12 carbon atoms containing a 3- to 6-membered alicyclic structure.

5. The optical film according to claim 1, wherein the monocarboxylic acid is an aliphatic monocarboxylic acid having from 2 to 10 carbon atoms.

6. The optical film according to claim 1, wherein the polyester has a hydroxyl group value of 10 mgKOH/g or less.

7. The optical film according to claim 1, wherein a content of the polyester is from 5 to 20% by mass based on the cellulose ester.

8. A polarizing plate comprising at least one sheet of an optical film, wherein the optical film comprises:
a cellulose ester and
at least one kind of a polyester containing an alicyclic structure and having a hydroxyl terminal group, a hydrogen atom of which is substituted by an acyl group derived from a monocarboxylic acid, and
has:
a thickness of from 10 to 45 μm,
an in-plane retardation Re at a wavelength of 590 nm under an environment of 25° C. and 60% RH of from −5 to 5 nm,
a retardation in thickness direction Rth at a wavelength of 590 nm under an environment of 25° C. and 60% RH of from −5 to 5 nm, and
an elastic modulus of 4.2 GPa or more.

9. A liquid crystal display device comprising a liquid crystal cell and two sheets of polarizing plates disposed on both sides of the liquid crystal cell, wherein at least one of the polarizing plates comprises at least one sheet of an optical film and the optical film comprises:
a cellulose ester and
at least one kind of a polyester containing an alicyclic structure and having a hydroxyl terminal group, a hydrogen atom of which is substituted by an acyl group derived from a monocarboxylic acid, and
has:
a thickness of from 10 to 45 μm,
an in-plane retardation Re at a wavelength of 590 nm under an environment of 25° C. and 60% RH of from −5 to 5 nm,
a retardation in thickness direction Rth at a wavelength of 590 nm under an environment of 25° C. and 60% RH of from −5 to 5 nm, and
an elastic modulus of 4.2 GPa or more.

10. The liquid crystal display device according to claim 9, wherein the liquid crystal cell is an in-plane switching mode, IPS, liquid crystal cell.

11. The liquid crystal display device according to claim 9, wherein an optical film is disposed between a polarizer and the liquid crystal cell and the optical film comprises:
a cellulose ester and
at least one kind of a polyester containing an alicyclic structure and having a hydroxyl terminal group, a hydrogen atom of which is substituted by an acyl group derived from a monocarboxylic acid, and
has:
a thickness of from 10 to 45 μm,
an in-plane retardation Re at a wavelength of 590 nm under an environment of 25° C. and 60% RH of from −5 to 5 nm,
a retardation in thickness direction Rth at a wavelength of 590 nm under an environment of 25° C. and 60% RH of from −5 to 5 nm, and
an elastic modulus of 4.2 GPa or more.
